(19) United States
(12) Patent Application Publication
(10) Pub. No.: US 2010/0255267 A1
(43) Pub. Date: Oct. 7, 2010

(54) MOLDING METHOD PROVIDING THREE-DIMENSIONAL PATTERNS IN-MOLD AND ARTICLES MOLDED BY THE METHOD

(75) Inventor: CHUN-YUAN CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/752,136

(22) Filed: Apr. 1, 2010

(30) Foreign Application Priority Data
Apr. 7, 2009 (CN) 200910301382.0

(51) Int. Cl. B32B 3/10; B29C 45/16

(52) U.S. Cl. 428/187; 156/245

(57) ABSTRACT

A method for forming three-dimensional patterns on a molded particle utilizing a mold with a male mold and a female mold defining a mold cavity, a three-dimensional pattern provided inside the mold cavity; providing an attachment film; transporting the attachment film into the mold, and providing a predetermined section of the attachment film closely applied to the mold cavity; closing the mold; closing the mold again, enabling the parting surface of the male mold and the parting surface of the female mold to contact each other, and cutting the predetermined section from the attachment film; stopping injection of plastic material; opening the mold and pushing out a molded article with three dimensional patterns corresponding to the patterns provided inside the mold cavity. A molded article made of the foregoing method is also disclosed.

### BACKGROUND

1. Technical Field

The present application is related to formation of three dimensional patterns in-mold on molded articles and articles molded by the method.

2. Description of Related Art

Portable electronic devices (such as mobile phones and electronic notebooks) are in widespread use. The external appearance of the housing of the portable electronic device has become a key factor for attracting consumers.

The external appearance of the housing is often made by In-Mold Roller (IMR) process. The IMR process comprises: printing ink on a film to form an ink layer, positioning the film to correspond to the mold cavity of the a mold by a transporter, closing the mold, injecting plastic material into the mold cavity, opening the mold and separating the ink layer from the film. The film also comprises a separation layer and a hardening layer, both stripped from the molded article after opening the mold. Edges of the hardening layer are not flush with edges of the ink layer attached on the molded articles. Thickness of the hardening layer is usually less than five micrometers, so it is easy to be scratched. After being stripped off, the separation layer and the hardening layer can not be used again.

Therefore, a method providing a decoration layer on a molded article with lower cost and increased hardness is desired.

### BRIEF DESCRIPTION OF THE DRAWINGS

FIG. 1 is a cross-section view of a mold used in an embodiment of a method for forming three-dimensional patterns on molded articles inside a mold as disclosed.

FIG. 2 is a cross-section view of another mold used in the method for forming three-dimensional patterns on molded articles as disclosed.

FIG. 3 is a drawing showing a first closing status of the mold of FIG. 1, the male mold and the female mold not in contact, and melted plastic material prepared for injection into the mold.

FIG. 4 is a drawing showing a second closing status of the mold of FIG. 1, with the male mold and the female mold in contact, and the injection of melted plastic material is completed, meanwhile a cutting part of the male mold cuts down a predetermined section of the attachment film.

FIG. 5 is a flowchart of a first embodiment of a method for forming three-dimensional patterns on molded articles inside a mold as disclosed.

FIG. 6 is a flowchart of a second embodiment of a method for forming three-dimensional patterns on molded articles inside a mold as disclosed.

FIG. 7A is a perspective view of a molded article formed by the method disclosed.

FIG. 7B is a cross-section view taken along a line 7B-7B in FIG. 7A.

FIG. 8A is a perspective view of another molded article formed by the method as disclosed.

FIG. 8B is a cross-section view taken along a line 8A-8B in FIG. 8A.

FIG. 9 is a partial, cross-section view taken along a line 9-9 in FIG. 7B, showing three-dimensional patterns of an attachment film.

### DETAILED DESCRIPTION

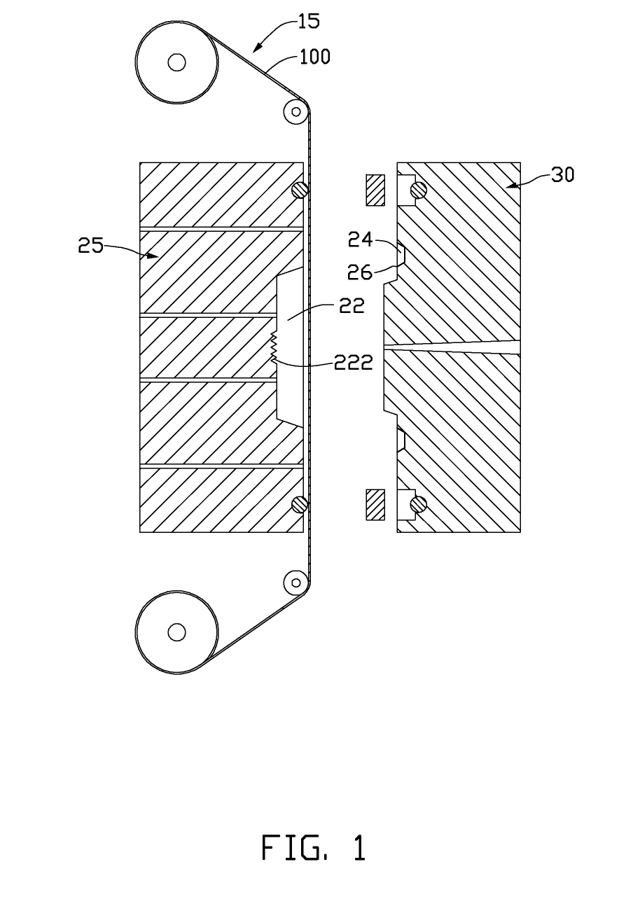

FIG. 1 is a cross-section view of a mold used in an embodiment of a method for forming three-dimensional patterns on molded articles as disclosed. The mold comprises a transporter 15, a female mold 25 and a male mold 30. The transporter 15 comprises a pair of film transporting rollers (not labeled), provided on the upper side and the lower side of the mold respectively, to transport the film. The transporter 15 also comprises a direction roller (not labeled) to direct the film to a correct transport position.

A mold cavity 22 is provided in the female mold 25. A three-dimensional pattern 222 can be provided in the bottom of the mold cavity 22 through chemical etching or curving by cutting tools. The three-dimensional pattern 222 also can be obtained by applying photoresistance on a predetermined section of the substrate of the female mold in a predetermined pattern, followed by exposure and development with the photoresistance on the predetermined section.

Several exhaust slots are provided on one side of the female mold 25 opposite to the mold cavity, connected to an exhausting device, to make the film sent by the transporter 15 attached inside the mold cavity 22.

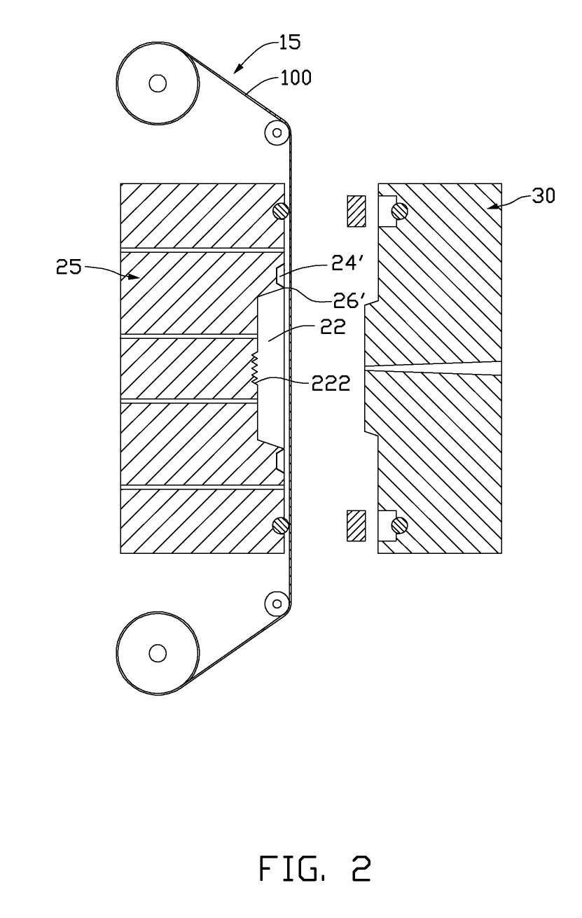

The male mold 30 comprises a parting surface on which a recess 24 is defined. The male mold 30 also comprises a cutting part 26 to cut a predetermined section of the film which corresponds to the mold cavity 22 of the female mold 25. An injection nozzle is provided on the center of the accommodative part to inject melted plastic material into the mold cavity 22 of the female mold 25. As shown in FIG.2, another embodiment of a mold, a recess 24′ can be defined on the parting surface of the female mold 25 along the mold cavity 22, and a cutting part 26′ is formed around the mold cavity 22.

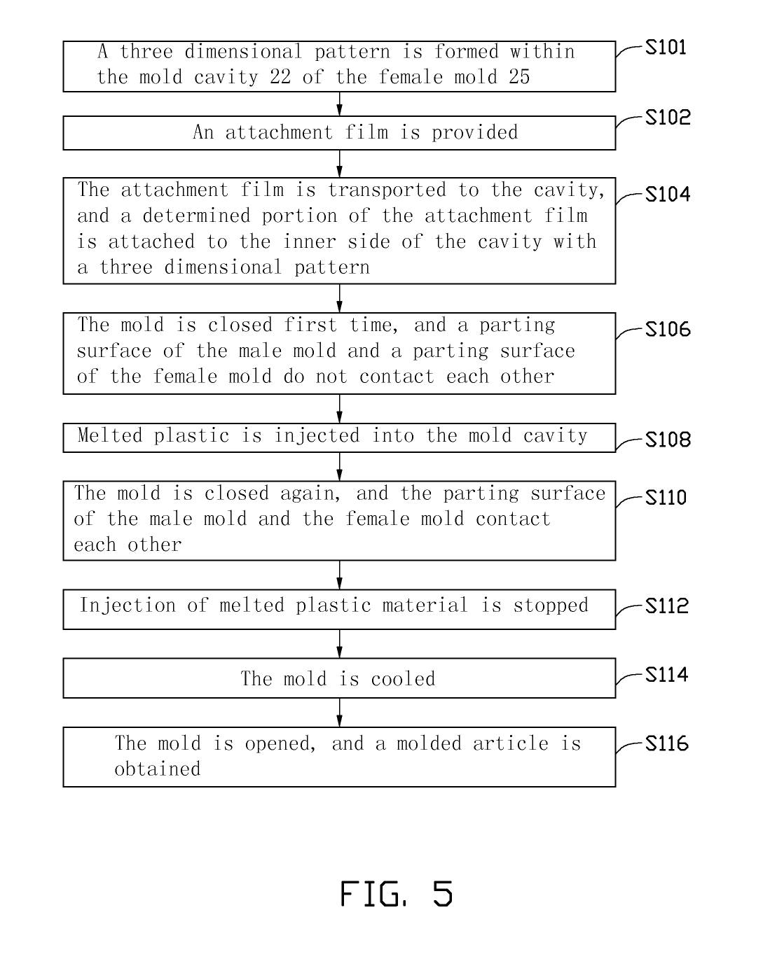

In FIG. 5, a flowchart of a first embodiment of a method for forming three-dimensional patterns on a molded article shows. In block S101, a three dimensional pattern is formed within the mold cavity 22 of the female mold 25. In block S102, an attachment film 100 is provided. In block S104, the attachment film 100 is transported to the position between the female mold 25 and the male mold 30 along the parting surface of the female mold 25 by the transporter 15. A determined portion of the attachment film 100 is attached to the inner side of the cavity 22 of the female mold 25, which comprises a three dimensional pattern. The attachment is preferably implemented by exhausting air from inside the mold cavity 22, with the attachment film 100 attached closely to the mold cavity 22 thereby.

In block S106, the mold is closed for a first time, and a parting surface of the male mold 30 and a parting surface of the female mold 25 do not contact each other. In block S108, melted plastic material is injected into the mold cavity 22 until 90%-95% of the space of the mold cavity 22 is filled, and a mold base is formed. The attachment film 100 is now attached on the surface of the mold base and a dimensional pattern is formed on the attachment film.

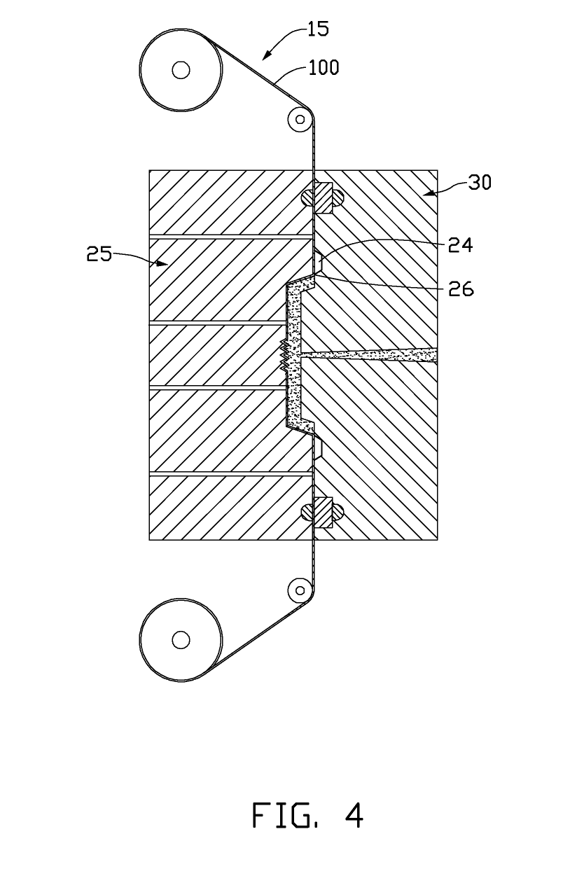

In block S110, the mold is closed again, and the parting surface of the male mold 30 and the female mold 25 contact each other. As shown in FIG. 4, melted plastic material is injected into the mold. Squeezed by the male mold 30, the cutting part 26 of the male mold 30 cuts off the predetermined section of the attachment film 100 attached on the mold base with the three dimensional pattern corresponding to the pattern 222. In step S112, melted plastic material injection stops. In step S114, the mold is cooled. In step S116, the mold is opened, and a molded article is obtained. Commensurately, the transporter 15 removes the attachment film 100 from the male mold 30 and the female mold 25, and a subsequent molding cycle begins.

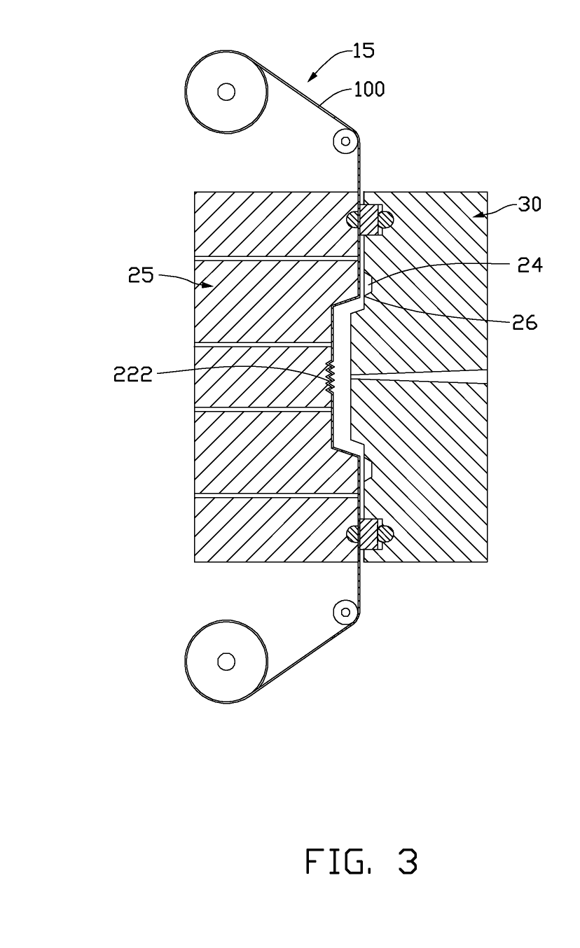

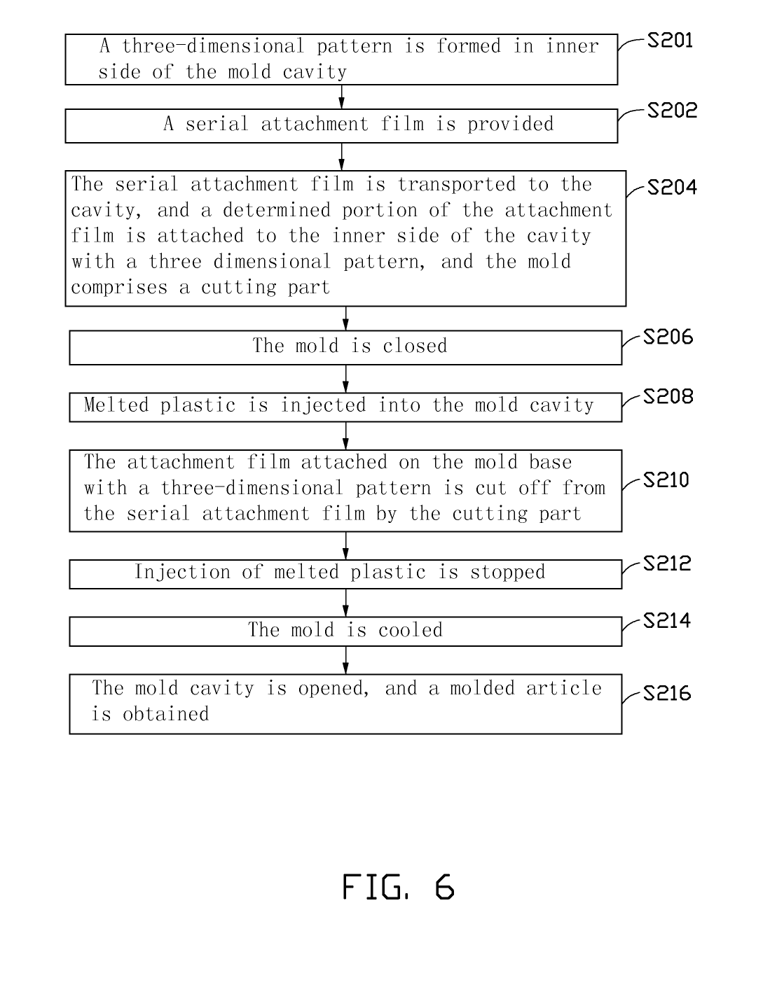

FIG. 6 is a flowchart of a second embodiment of a method for forming three-dimensional patterns on a molded article. In block S201, a three-dimensional pattern is formed in the inner side of the mold cavity 22. In block S202, a serial attachment film 100 is provided. In block S204, the serial attachment film 100 is transported to a position between the female mold 25 and the male mold 30 along the parting surface of the female mold 25 by the transporter 15. The mold comprises a cutting part 26. The transportation process can be referred to FIG. 3. In block S206, the mold is closed. In block S208, melted plastic material is injected into the mold cavity 22 to form a mold base, and the attachment film 100 is attached on the mold base. In block S210, the attachment film 100 attached on the mold base with a three-dimensional pattern corresponding to the pattern in block S201 is cut off from the serial attachment film by the cutting part 26 or 26′. In block S212, injection of melted plastic material is completed. In block S214, the mold is cooled. In block S216, the mold cavity is opened, and a molded article is obtained. The molded article have the attachment film 100 with a three-dimensional pattern corresponding to the pattern in block S201.

Molded articles formed by the method of the present application have colorful three-dimensional patterns with higher hardness than those made by conventional molding techniques, and are not easily damaged by abrasion. Furthermore, molded articles formed by the method of the present application have uneven and rough surface that are able to prevent slight oil dirt. The disclosed method is suitable for serial automatic production, and has increased efficiency and quality in molding articles.

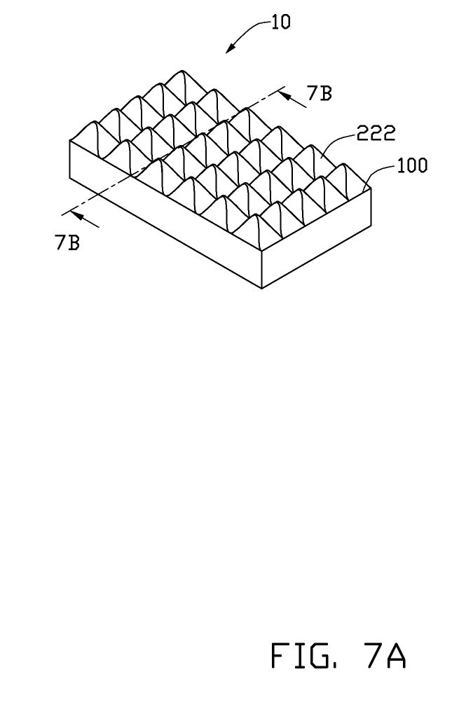

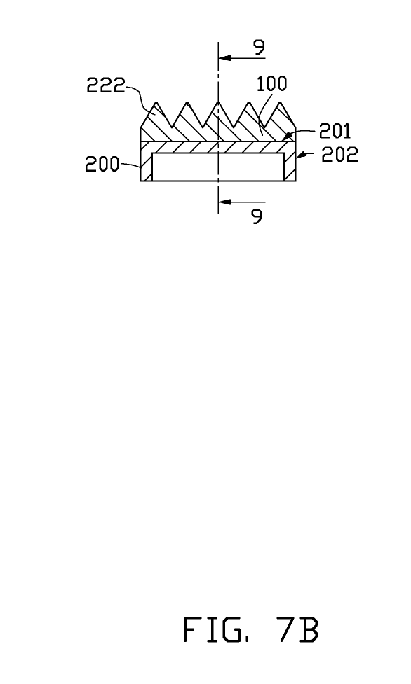

Please refer to FIG. 7A and FIG. 7B, showing a shell 10 formed by the method disclosed, comprising a substrate 200 and an attachment film 100 with a three-dimensional pattern corresponding to the pattern 222. The substrate 200 comprises a top surface 201 and an edge 202 surrounding the top surface 201. The attachment film 100 is attached on and envelopes the top surface 201.

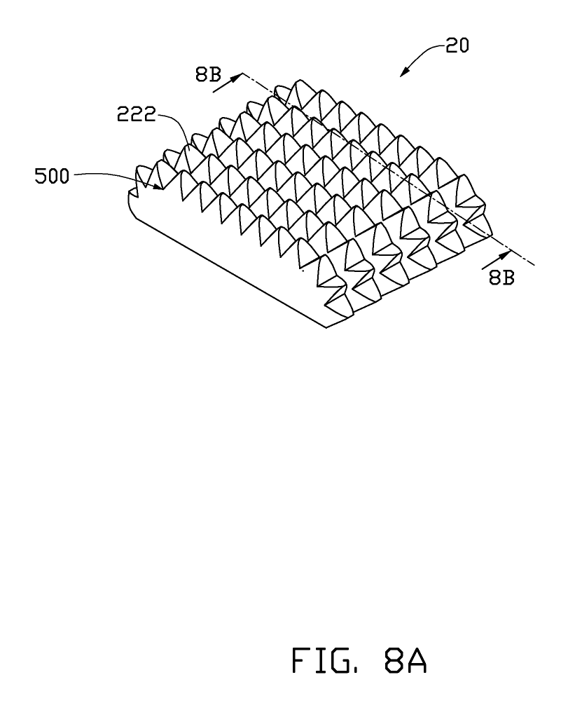

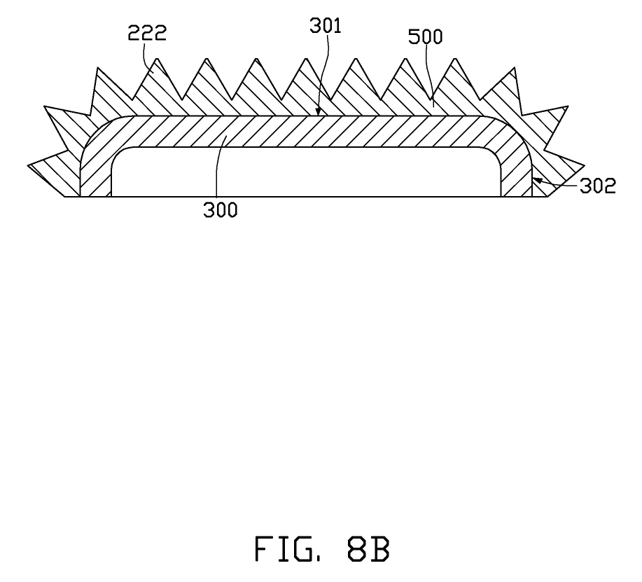

FIG. 8A and FIG. 8B show another shell 20 formed by the method disclosed, comprising a substrate 300 and an attachment film 500 with a three-dimensional pattern corresponding to the pattern 222. The substrate 300 comprises a top surface 301 and an edge 302 surrounding the top surface 301. The attachment film 500 is attached on the substrate 300 enveloping the top surface 301 and the side edge 302.

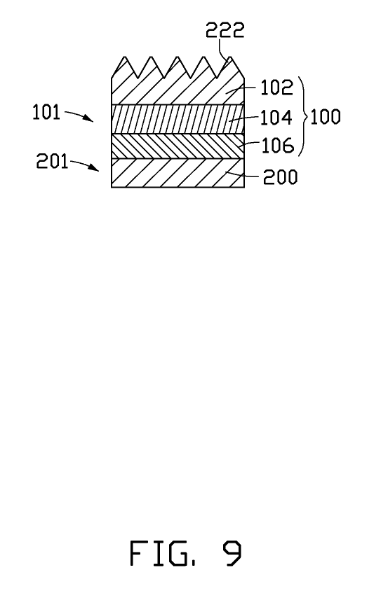

Please refer to FIG. 9, a cross-section view along a line 9-9 in FIG. 7B, in which the attachment film 100 comprises a base layer 103, a decoration layer 104 and an adhesive layer 106. The base layer 102 is scrolled and received in the transporter, and a three-dimensional pattern is formed by squeezing the base layer 102 with the three dimensional pattern 222 in the mold cavity 22. The three-dimensional pattern is attached to surface of the base 200, protecting the decoration layer 104 and the base 200 from abrasion and scratching. The base 102 generally is made of one or more material consisting of: polycarbonate (PC), polyethylene terephthalate (PET), Polymethylmethacrylate (PMMA), oriented polypropylene (OPP), and polyvinyl chloride (PVC). The thickness of the base layer 102 is preferably within a range from 0.01 millimeters to 0.125 millimeters (mm).

The decoration layer 104 is formed on the base layer 102 by color ink application to provide color or patterns. The decoration layer 104 can also be formed by vapor deposition or sputtering of a metal layer on the base layer 102, to provide a metallic sheen. The metal can be selected from one or more material in the group consisting of aluminum, chrome, copper, nickel, indium, and tin.

The adhesive layer 106 combines the attachment film 100 with the substrate 200. The adhesive layer 106 can be made by one or more material selected from the group consisting of: polyurethane resin, chlorinated rubber, vinyl chloride-vinyl acetate copolymer resin, polyamide resin, polyester resin, epoxy resin, polycarbonate resin, alkene resin, and vinyl cyanide-butylene-styrene resin. The adhesive layer 106 can be printed on the base layer 102 by gravure printing, screen printing, or flexography. The adhesive layer 106 can also be applied on the base layer 102 by spray coating or brush coating.

The base layer 102 of the attachment film 100 is embodied as transparent or translucent to show patterns and color of the decoration layer 104, which corresponds to the three-dimensional pattern 222 of the mold cavity 22.

The substrate 200 includes a second end surface 201 of a circumferential edge, and the attachment 100 includes a first end surface 101 of a circumferential edge, wherein the second end surface 201 of a circumferential edge is flush with the first end surface 101 of a circumferential edge.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming three-dimensional patterns on a molded article, the method comprising:
providing a mold with a male mold and a female mold defining a mold cavity, a three-dimensional pattern provided inside the mold cavity;
providing an attachment film;
transporting the attachment film into the mold, and applying a predetermined section of the attachment film closely to the mold cavity;
closing the mold, wherein a parting surface of the male mold and a parting surface of the female mold are separate from each other;
injecting plastic material into the mold cavity;
closing the mold further, enabling the parting surface of the male mold and the parting surface of the female mold to contact each other, and cutting the predetermined section from the attachment film;
stopping injection of plastic material;
opening the mold and pushing out a molded article with three dimensional patterns corresponding to the patterns provided inside the mold cavity.

2. The method for forming three-dimensional patterns on a molded particle as claimed in claim 1, wherein the attachment film comprises a base layer and an adhesive layer.

3. The method for forming three-dimensional patterns on a molded particle as claimed in claim 2, wherein the attachment film further comprises a decoration layer provided between the base layer and the adhesive layer.

4. The method for forming three-dimensional patterns on a molded particle as claimed in claim 2, wherein the base layer is made of one or more polymer materials selected from the group consisting of polycarbonate (PC), polyethylene terephthalate (PET), polymethylmethacrylate (PMMA), oriented polypropylene (OPP), and polyvinylchloride (PVC).

5. A method for forming three-dimensional patterns on a molded particle, the method comprising:
providing a mold with a male mold and a female mold defining a mold cavity, a three-dimensional pattern provided inside the mold cavity;
providing a serial attachment film;
transporting the attachment film into the mold, and applying a predetermined section of the attachment film closely to the mold cavity, wherein the mold comprises a cutting part;
closing the mold;
injecting plastic material into the mold cavity;
cutting the predetermined section from the sequential attachment film with the cutting part;
stopping injection of plastic material;
opening the mold and taking out a molded article with three dimensional patterns corresponding to the patterns provided inside the mold cavity.

6. The method for forming three-dimensional patterns on a molded particle as claimed in claim 5, wherein the attachment film comprises a base layer and an adhesive layer.

7. The method for forming three-dimensional patterns on a molded particle as claimed in claim 6, wherein the attachment film further comprises a decoration layer provided between the base layer and the adhesive layer.

8. The method for forming three-dimensional patterns on a molded particle as claimed in claim 6, wherein the base layer is made of one or more materials selected from the group consisting of polycarbonate (PC), polyethylene terephthalate (PET), polymethylmethacrylate (PMMA), oriented polypropylene (OPP), and polyvinylchloride (PVC).

9. A molded article formed by the method of claim 1 for forming three-dimensional patterns on a molded particle, wherein the molded article is provided with three-dimensional patterns.

10. The molded article as claimed in claim 9, wherein the molded article comprises a substrate having a first end surface of a circumferential edge thereof, and an attachment film having a second end surface of a circumferential edge thereof, and the first end surface is substantially flush with the second end surface.

11. The molded article as claimed in claim 10, wherein the attachment film comprises a base layer and an adhesive layer.

12. The molded article as claimed in claim 11, wherein the attachment film comprises a first decoration layer provided between the base layer and the adhesive layer.

13. The molded article as claimed in claim 12, wherein the attachment film further comprises a second decoration layer provided on an upper surface of the base layer.

14. The molded article as claimed in claim 11, wherein the base layer is made of one or more polymer material selected from the group consisting of polycarbonate (PC), polybutylene terethalate (PBT), polyethylene terephthalate (PET), polymethylmethacrylate (PMMA), oriented polypropylene (OPP), and polyvinylchloride (PVC).

15. A molded article formed by the method of claim 5 for forming three-dimensional patterns on a molded particle, wherein the three-dimensional patterns corresponding to the patterns inside the mold cavity are provided on surface of the molded article.

16. The molded article as claimed in claim 15, wherein the molded article comprises a substrate having a first end surface of a circumferential edge thereof, and an attachment film having a second end surface of a circumferential edge thereof, and the first end surface is substantially flush with the second end surface.

17. The molded article as claimed in claim 16, wherein the attachment film comprises a base layer and an adhesive layer.

18. The molded article as claimed in claim 17, wherein the attachment film comprises a first decoration layer provided between the base layer and the adhesive layer.

19. The molded article as claimed in claim 18, wherein the attachment film further comprises a second decoration layer provided on an upper surface of the base layer.

20. The molded article as claimed in claim 17, wherein the base layer is made of one or more polymer material selected from the group consisting of polycarbonate(PC), polybutylene terethalate (PBT), polyethylene terephthalate (PET), polymethylmethacrylate (PMMA), oriented polypropylene (OPP), and polyvinylchloride (PVC).
